(19) United States
(12) Patent Application Publication
(10) Pub. No.: US 2024/0044409 A1
(43) Pub. Date: Feb. 8, 2024

(54) ROTARY SEAL ASSEMBLY WITH OIL-SIDE FOAM RING

(71) Applicant: Trelleborg Sealing Solutions Germany GmbH, Stuttgart (DE)

(72) Inventors: Mandy Wilke, Boeblingen (DE); Holger Jordan, Neuhausen (DE); Tobias Corneli, Kastellaun (DE)

(73) Assignee: Trelleborg Sealing Solutions Germany GmbH, Stuttgart (DE)

(21) Appl. No.: 18/491,724

(22) Filed: Oct. 20, 2023

Related U.S. Application Data
(63) Continuation of application No. PCT/EP2022/067895, filed on Jun. 29, 2022.

(30) Foreign Application Priority Data
Jun. 29, 2021 (DE) 10 2021 206 769.7

(51) Int. Cl. F16J 15/3284; F16J 15/3232

(52) U.S. Cl. CPC F16J 15/3284; F16J 15/3232

(57) ABSTRACT

A rotary seal arrangement includes a first machine part being a shaft and a second machine part encompassing the shaft. The first and second machine parts are spaced apart and rotatable relative to one another forming a sealing gap. A seal holding structure is formed on one of the two machine parts. A rotary seal has a foot section and a sealing lip connected via a connecting section. The foot section is arranged on or in the seal holding structure. The sealing lip rests sealingly on a sealing surface of the respective other machine part to seal an oil side from an outside of the rotary seal arrangement. On the oil side there is a foam ring with a base body and with a holding section which surrounds the first machine part and which is held on the foot section of the rotary seal via the holding section.

### CROSS-REFERENCE TO RELATED APPLICATIONS

This continuation application claims priority to PCT/EP2022/067895 filed on Jun. 29, 2022 which has published as WO 2023/275141 A1 and also the German application number DE 10 2021 206 769.7 filed Jun. 29, 2021, the entire contents of which are fully incorporated herein with these references.

### DESCRIPTION

### Field of the Invention

The invention relates to a rotary seal assembly with a rotary seal. The rotary seal assembly comprises a first machine part in the form of a shaft and a second machine part which engages around the shaft, wherein the shaft and the second machine part are spaced apart from one another with the formation of a sealing gap and are arranged adjustably or movably relative to one another about an axis of rotation. A seal-holding structure is formed on one of the two machine parts. The rotary seal has a foot portion and a sealing lip which are connected to one another via a connecting portion. The foot portion is arranged to be held on or in the seal-holding structure of the one machine part. The sealing lip bears against a sealing surface of the respective other machine part in a dynamically sealing manner in order to seal off an oil or high-pressure side H from an outer or low-pressure side N of the rotary seal assembly. A foam ring with a base body and with a holding portion is arranged at the oil side, wherein the foam ring engages around the first machine part and is arranged so as to be held on the foot portion of the rotary seal via the holding portion.

### Background of the Invention

Such a rotary seal assembly is known for example from JP 2017 026072 A. In this known rotary seal assembly, a sealing ring having a sealing lip serves to seal a rotating shaft. An annular, foam-elastic, grease-penetrating member is arranged at one side of the sealing lip and is in contact with the shaft. In the grease-penetrating member, grease is held in a penetrating state.

A rotary seal assembly known from JP 6 460751 B2 has a sealing ring with a sealing lip and an annular filter element, which is arranged at one side of the sealing lip and is made of foam material.

Finally, DE 10 2008 035315 A1 discloses a sealing device with an annular shielding element made of foam.

In operational use of the known rotary seal assemblies, wear and other contaminants can lead to damage and thus inherently to a malfunction and even a functional failure of the rotary seal. This is associated with risks, in particular, in the case of critical applications. In operational use of the rotary seal assembly, the reliable lubrication of the dynamic sealing region of the rotary seal is furthermore vital. In this regard, in particular, special surface structures of the rotary seal which are also referred to as tribological structures have been shown to be advantageous.

DE 10 2013 212 960 A1 discloses, for even greater protection of the dynamic sealing lip of a rotary seal, a foam body which is fastened to the sealing lip. The foam body bears during operational use jointly with the sealing edge against the contact surface, which is to be dynamically sealed off, of a machine part and can be arranged on the outer side or also on the oil side of the sealing lip. As a result of the foam ring, malfunctions can, however, arise in operational use, in particular, inferior response characteristics of the sealing lip to changes in the oil-side operating pressure or to an eccentricity of the shaft to be sealed off.

### SUMMARY OF THE INVENTION

Against this background, the object of the invention is to indicate a rotary seal assembly which enables on one hand improved protection of the sealing region of the rotary seal from particulate contaminants as well as improved lubrication of the sealing region without the sealing capacity or response characteristics of the rotary seal being influenced as a result.

This object is achieved by a rotary seal assembly with the features indicated in claim 1.

The rotary seal assembly according to the invention is characterized by a foam ring arranged on the oil side with a base body and with a holding portion which engages around the first machine part and which is arranged so as to be held on the foot portion of the rotary seal via the holding portion. The foam ring can be formed at least partially, preferably substantially entirely, from a closed-celled, an open-celled or a mixed closed-celled/open-celled foam. On one hand, particles which accumulate on the oil side of the sealing gap, i.e., on the oil side, or particulate contaminants such as, for example, abrasively acting material abrasion or oxidation products of lubricating oil can be held back (filtered), absorbed or adsorbed onto the material of the foam by the foam ring. Moreover, the foam ring can be soaked with lubricant arranged on the oil side, for example, by way of capillary forces, and thus serve in the sealing gap as a lubricant store. As a result of this, undesirable running dry of the rotary seal in the sealing region, i.e., in the region of the sealing edge, which bears in a dynamically sealing manner against the sealing surface, of the sealing lip can be counteracted. Overall, a protective effect for the rotary seal can thus be achieved by the foam ring. This is advantageous for the service life of the rotary seal.

According to the invention, the base body can be embodied on its circumferential side facing the sealing surface in the unloaded, unmounted state of the foam ring or in the mounted state of the foam ring in a corrugated manner in a direction which is orthogonal to the sealing surface. In the case of the former embodiment variant, the corrugated nature of the circumferential side facing the sealing surface in the installation state of the foam ring is thus no longer present or is eliminated. In the case of the latter embodiment variant, the foam ring bears in its circumferential direction only in portions against the sealing surface of the respective other machine part (shaft).

Alternatively or additionally, the foam ring can have a second circumferential side which faces the machine part having the seal-holding structure and which is embodied in a corrugated manner in the unloaded, non-installed state of the foam ring or in the installed state of the foam ring.

The circumferential side of the foam ring which faces the sealing surface and/or the circumferential side of the foam ring which faces away from the sealing surface can therefore have in each case bulges and/or recesses which are arranged on the circumferential side, in particular, at regular distances. The recesses and/or the bulges can be formed, for example, to be mound-shaped, hemispherical, semicircular, spherical, ball segment-shaped, trapezoidal or polygonal, with a combination of these shapes also being possible.

If the foam ring has the recesses and/or the bulges on both circumferential sides, i.e., if the foam ring is formed to be corrugated on both circumferential sides, the bulges and/or the recesses can be arranged in pairs flush with one another in each case in the radial direction. An arrangement of the recesses and/or the bulges offset to one another is also possible. For example, the bulges and/or recesses can be formed offset in pairs relative to one another 90° about the circumference. In the case of the above-mentioned corrugated embodiment variants, a variable contact pressure of the sealing ring and the sealing surface thus arises during operational use of the rotary seal assembly in the circumferential direction. As a result of this, a particularly efficient take-up/discharge of lubricant in/on the foam ring can be achieved during operational use. As a result of this, tribological advantages furthermore arise.

According to the invention, both the holding portion and also the base body are preferably formed from the closed-celled, open-celled or mixed closed-celled/open-celled foam. As a result of this, the foam ring can be produced in one piece, for example, by foam molding or by extrusion, in a technically simple and low-cost manner.

According to one alternative embodiment of the invention, the base body is formed from the closed-celled, open-celled or mixed closed-celled/open-celled foam.

The base body projects according to the invention preferably from the holding portion in the direction of the sealing surface so that substantially a recess in the second machine part in which the rotary seal assembly is arranged is fully covered in the radial direction by the base body. In other words, the rotary seal assembly is preferably shielded completely by the base body perpendicular to the axis of rotation or in a radial direction. In operational use of the rotary seal assembly, all the lubricant that reaches the sealing edge flows firstly through the foam. This is advantageous because as a result of this a large quantity of particles or other impurities in the sealing gap or in the lubricant can be filtered.

Due to the fact that the foam ring is arranged held on the foot portion of the rotary seal, a mechanical or functional decoupling of the foam ring and the sealing lip can furthermore be achieved. For this purpose, the foam ring is arranged preferably spaced apart from the sealing lip and a sealing edge, which may be present, of the sealing lip. The sealing capacity as well as the response characteristics of the sealing lip to an eccentricity of the shaft or a change in the operating pressure which prevails on the sealing lip on the oil side is thus not disadvantageously influenced by the foam ring. At the same time, the sealing lip and its possible deflection movements also still have no functional influence or substantially no functional influence on the foam ring. It should be noted that the foam ring can also be retrofitted in the case of existing rotary seals such that the respective rotary seal assemblies have the functionality of the present invention.

According to the invention, the foam ring extends directly from the foot portion of the rotary seal in the direction of the longitudinal extent of the connecting portion, i.e., in the case of a rotary seal formed as a radial shaft sealing ring in a direction which is radial to the axis of rotation, up to the height of the sealing edge or almost up to the height of the sealing edge of the rotary seal.

According to one particularly preferred further development of the invention, the foam ring extends directly from the foot portion of the rotary seal in the direction of the longitudinal extent of the connecting portion, i.e., in the case of a rotary seal formed as a radial shaft sealing ring in a direction which is radial to the axis of rotation, up to the height of the sealing edge or almost up to the height of the sealing edge of the rotary seal. According to a further embodiment, the foam ring can extend from the machine part having the seal-holding structure up to the sealing surface. The foam ring bears directly against both machine parts in this case.

According to a further development of the invention, the holding portion extends away from the base body in a lateral direction. In particular, the holding portion extends from the base body substantially in an axial direction away from the base body. As a result of this, the mounting of the foam ring on the rotary seal can be simplified.

The holding portion can have holding segments arranged spaced apart from one another in the circumferential direction of the foam ring or, however, be embodied to be annularly closed.

According to the invention, the foam ring can be held in a clamped manner, preferably exclusively in a clamped manner, via the holding portion on the rotary seal. As a result of this, the mounting of the foam ring can be brought about in a particularly simple manner.

For the purpose of particularly reliable positional securing of the foam ring on the rotary seal, the holding portion of the foam ring according to the invention preferably extends up to the connecting portion of the rotary seal. The connecting portion of the rotary seal thus forms in this case for the foam ring a mounting stop, by which the mounting of the foam ring on the rotary seal is further simplified.

According to the invention, the holding portion and the foot portion of the rotary seal can be embodied in each case in a corrugated manner. Here, each corrugation of the holding portion of the foam ring or of the foot portion of the rotary seal preferably extends in the circumferential direction of the corresponding component. In the mounted state, the corrugations of the two components mesh in one another, as a result of which the foam ring is secured against unintentional disconnection from the rotary seal.

According to one preferred further development of the invention, the rotary seal and/or the foam ring is provided with a reinforcement layer.

The respective reinforcement layer preferably has an L-shaped cross-sectional shape. In the case of the rotary seal, as a result of this, on one hand a reliable anchoring of the rotary seal in/on the seal-holding structure is enabled. In the case of the foam ring, this can be fastened to the rotary seal particularly reliably, in particular, by clamping. A foam material with a low degree of dimensional stability can thus furthermore also be used for the foam ring.

For a mechanically even more reliable fastening of the foam ring to the foot portion of the rotary seal, the foam ring can be secured via a latching connection or a screw connection, in particular, a bayonet connection, on the foot portion, in particular, on a reinforcement layer of the rotary seal.

Alternatively, the foam ring can have an additional device with which it can be fastened to the foot portion. The device can comprise, for example, a metal or a plastic or be formed from one of these materials. This can enable, in particular, a clip connection to the foot portion. In summary, the foam ring can be connected to the foot portion in a force-fitting and/or form-fitting and/or firmly bonded manner. This enables the use of the rotary seal assembly even in the case of high-speed applications or in the case of those applications in which an eccentricity of the shaft and thus an action of torque on the foam ring during operational use cannot be reliably prevented.

For even more reliable positional securing and even more precise positioning of the foam ring on the rotary seal, it has been shown to be advantageous in practice if the foam ring is supported at the free end of the foot portion additionally in an axial direction. To this end, the foam ring preferably has a bearing shoulder for the foot portion of the rotary seal.

The base body of the foam ring can, according to the invention, have in particular, a rectangular cross-sectional shape or a cross-sectional shape which tapers in the direction of the sealing surface. In the former case, particularly simple manufacturing of the foam ring arises. In the latter case, a predefined minimum contact surface pressure of the foam ring and the sealing surface can be realized in a simplified manner.

According to the invention, the foam ring bears preferably directly against the sealing surface of the respective other machine part. This can be the case all around or in the circumferential direction of the foam ring with interruptions. In the case of the former embodiment, possibly abrasively acting particulate contaminants can be kept particularly effectively away from the sealing region of the sealing lip of the rotary seal.

The base body of the foam ring or the entire foam ring can according to the invention be formed at least partially, preferably substantially entirely, from a closed-celled, an open-celled or a mixed closed-celled/open-celled foam. An open-pored foam enables a particularly high absorption capacity of the foam ring for lubricant. The closed-celled embodiment enables in contrast particularly pronounced capillary effects as well as higher dimensional stability of the foam ring.

According to the invention, the foam ring can have several radial channels which extend in a radial direction from the circumferential side, facing the sealing surface, of the foam ring into the foam ring. These radial channels preferably have a cross-section between 0.5 and 2.0 millimeters. As a result of this, a capillary force-induced absorption of lubricant can be yet further facilitated.

According to the invention, the rotary seal is preferably pressure-activated. In this case, the foam ring can according to the invention be provided with an axial through-bore or with several axial through-bores.

According to the invention, the rotary seal preferably has a dust lip which points toward the outer side of the sealing gap. As a result of this, undesirable penetration of contaminants from the outside into the sealing gap can be even more reliably counteracted.

The sealing lip bears against the sealing surface according to the invention preferably by means of a pretensioning element, in particular, by means of a worm spring, in a pretensioned sealing manner against the sealing surface.

The foam ring advantageously bears directly against the machine part which has the seal-holding structure.

The rotary seal and the foam ring can according to the invention be arranged in a sleeve-shaped cartridge of one of the two machine parts. As a result of this, the mounting of the rotary seal assembly can be further simplified.

According to a further development of the invention, the foam ring is at least partially coated. In particular, the foam ring has a coating at least on its inner circumference and/or on its outer circumference, i.e., at least on the surface that faces the sealing surface, and/or on the surface that faces away from the sealing surface. The coating can result, for example, in a static charge such that particles and/or contaminants adhere to the foam ring and/or are absorbed in the foam ring. The coating can also, for example, bring about that the foam ring has a higher rigidity. The coating thus serves as a type of exoskeleton for the foam ring. The coating is advantageously arranged in the linking region of the holding portion on the base body in order to make it stiffer. An undesirable bending of the base body relative to the holding portion can be avoided as a result of this. In other words, as a result of this, a defined position of the base body and of the holding portion relative to one another can be ensured.

The foam ring according to the invention can additionally be provided with additives which bring about that the foam ring is, for example, hydrophilic, hydrophobic, lipophilic or lipophobic or antistatic or has a higher temperature resistance. If the foam ring is equipped in a hydrophilic manner, said foam ring can absorb, for example, water which is contained in the lubricant. The sealing edge of the seal is thus protected from water. As a result of this, the service life of the rotary seal assembly can be further improved.

If the foam ring is provided, for example, with lipophobic additives, as a result less lubricant is absorbed in the foam ring during operational use, as a result of which larger quantities of particles and/or dirt and suspended matter and/or other impurities can be absorbed by the foam ring. As a result of this, the service life of the rotary seal assembly can be further improved. The service life of the rotary seal assembly can also be increased by additives which increase the temperature resistance of the foam ring.

According to the invention, an additional foam ring can also be arranged on the low-pressure side or outer side of the rotary seal. The additional foam ring can be formed according to one of the aspects described above. In other words, a respective foam ring can be arranged both on the high-pressure side and on the low-pressure side. As a result of this, it can be ensured that the sealing edge is protected from dirt on both sides.

Further advantages of the invention will become apparent from the description and the drawing.

The invention is explained in greater detail below on the basis of exemplary embodiments reproduced in the drawing. It will be obvious that the embodiments shown and described should not be understood as a definitive list, rather have an exemplary character to reflect the invention.

### BRIEF DESCRIPTION OF THE DRAWINGS

In the drawings:

FIG. 1 shows a rotary seal assembly with a first and a second machine part which are mounted rotatably relative to one another about an axis of rotation and with a rotary seal for sealing off an oil side of the sealing gap formed between the two machine parts, wherein a foam ring is arranged on the oil side, which foam ring is arranged so as to be clamped and held on the statically sealing foot portion of the rotary seal, in a sectional representation;

FIG. 2 shows the rotary seal assembly according to FIG. 1 in a further sectional representation in the region of the contact of the foam ring with the sealing surface of the first machine part;

FIG. 3 shows a further rotary seal assembly, in which the foam ring has an axial length which is larger in comparison with the foam ring according to FIG. 2;

FIG. 4 shows a further rotary seal assembly with a foam ring arranged on the oil side of the sealing gap and which has a cross-sectional shape which tapers in the direction of the sealing surface;

FIG. 5 shows a further rotary seal assembly, in which the foam ring bears in the radial direction against both machine parts and which is additionally supported on the foot portion in the axial direction;

FIG. 6 shows a further rotary seal assembly in a detailed cut-out, in which the foam ring is in threaded engagement with the foot portion of the rotary seal;

FIG. 7 shows a further rotary seal assembly in a detailed cut-out, in which the foot portion of the rotary seal has an annularly closed corrugation; and

FIG. 8 shows a foam ring in a perspective view.

### DETAILED DESCRIPTION OF EMBODIMENTS OF THE INVENTION

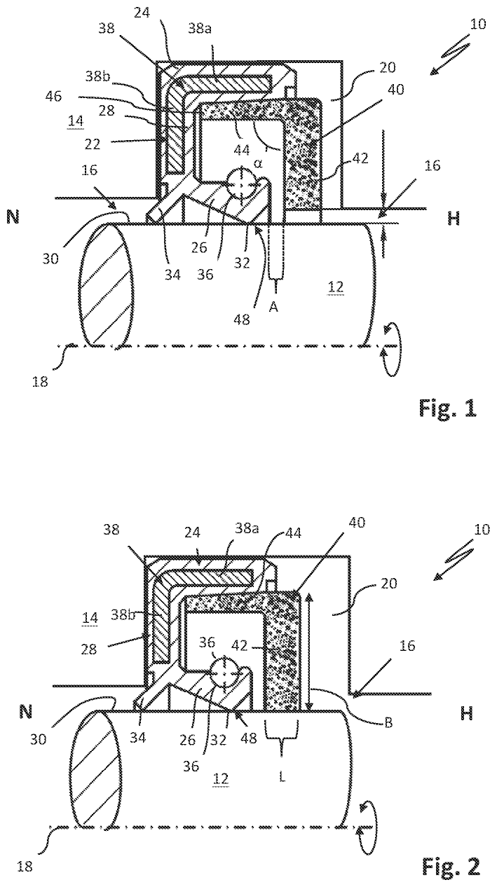

FIGS. 1 and 2 show a rotary seal assembly 10 with a first machine part 12 in the form of a shaft and with a second machine part 14 in the form of a housing which engages at least partially around the shaft. The shaft and the housing are arranged spaced apart from one another with the formation of a sealing gap 16. The shaft is rotatable here relative to the housing about an axis of rotation designated by 18. The second machine part 14 has a seal-holding structure 20 in the form of a groove. A rotary seal 22 serves to seal off an oil or high-pressure side H of the sealing gap 16 from the outer or low-pressure side N. The rotary seal 22 is formed from a rubber-elastic deformable material. The rotary seal 22 has a holding or foot portion 24 and a dynamic sealing lip 26 which are connected to one another via a connecting portion 28 which is arranged in a radially running manner. The sealing lip 26 extends substantially parallel to the sealing surface 30 of the first machine part 12 and has a sealing edge 32. Here, by way of example, a dust lip 34 which extends from the connecting portion 28 in an axial direction toward the outer side N and which bears against the sealing surface 30 is furthermore arranged on the connecting portion 28. The rotary seal 22 is arranged so as to be held with its foot portion 24 in the seal-holding structure 20. According to FIG. 1, the foot portion 24 is arranged with axial air in the seal-holding structure 20. The foot portion 24 bears against the second machine part 14 in a radial direction in a statically sealing manner.

The sealing lip 26 is prestressed by means of a worm spring 36 in the direction of and against the sealing surface 30. A reinforcement layer 38 serves to strengthen the rotary seal 22. The reinforcement layer 38 has here an L-shaped cross-sectional shape and is embodied in one piece. The reinforcement layer 38 is composed of a material which is more rigid, i.e., less deformable, in comparison with the rubber-elastic material of the rest of the rotary seal. In particular, viscoelastic plastics or also metal are considered here. A first leg 38a of the reinforcement layer 38 extends into the foot portion 24 of the rotary seal 22, a second leg 38b extends into the connecting portion 28.

A foam ring 40 is arranged on the oil side H of the sealing gap 16. The foam ring 40 has a base body 42 from which a holding portion 44 extends laterally in an axial direction. An angle α which is between 70° and 110° is formed between the base body 42 and the holding portion 44. The holding portion 44 is embodied here to be annular and in one piece with the base body 42 of the foam ring 40. The foam ring 40 engages around the first machine part 12 in a manner which corresponds to the rotary seal 22. The main body 42 is formed to be disc-shaped and has a central hole through which the shaft is guided. The difference between an inner circumferential diameter of the base body 42 and an outer circumferential diameter of the base body 42 defines a ring width B.

The foam ring 40 is fastened to the foot portion 24 of the rotary seal 22 exclusively by clamping. For this purpose, the holding portion 44 engages below the foot portion 24 in an axial direction and bears against it on the inside in the radial direction. As a result of the inherent elasticity of the foam material, the holding portion 44 bears against the foot portion 24 pretensioned in the radial direction. The holding portion 44 can extend with its free end 46 up to the connecting portion 28 of the rotary seal 22. The connecting portion 28 thus forms on one hand a mounting stop for the holding portion 44. As a result, on the other hand, an orientation, which runs strictly orthogonally to the axis of rotation 18, of the base body 42 of the foam ring 40 (or coaxial orientation of the foam ring 40) and also a defined distance A thereof to the sealing lip 26, in particular, to the sealing edge 32 or to the sealing region 48, to be supplied with lubricant, of the rotary seal arrangement 10, can also be achieved. The foam ring 40 bears against the sealing surface 30 in the circumferential direction with interruptions, i.e., in portions, as is shown in FIGS. 1 and 2. The foam ring 40 can bear against the sealing surface with a radial pretensioning.

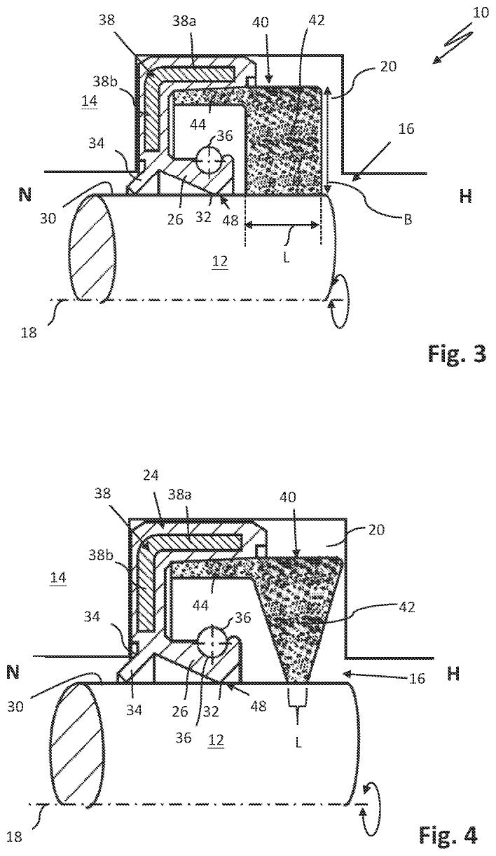

According to the exemplary embodiment shown in FIG. 3, the foam ring 40 can have a base body 42 with an axial length L which is larger than the embodiment shown in FIGS. 1 and 2. As a result, the foam ring 40 can have a greater retention capacity in relation to particulate contaminants in comparison with the exemplary embodiment according to FIGS. 1 and 2, i.e., a greater filter capacity, and can have a greater lubricant absorption capacity. The axial length L corresponds here approximately to ¾ of the radial annular thickness B.

For the purpose of greater contact surface pressure of the foam ring 40 on the sealing surface 30, the foam ring 40 according to FIG. 4 can have a cross-sectional shape which tapers toward the sealing surface 30. A capillary force-induced absorption of lubricating oil on the oil side of the sealing gap can furthermore be facilitated by this design.

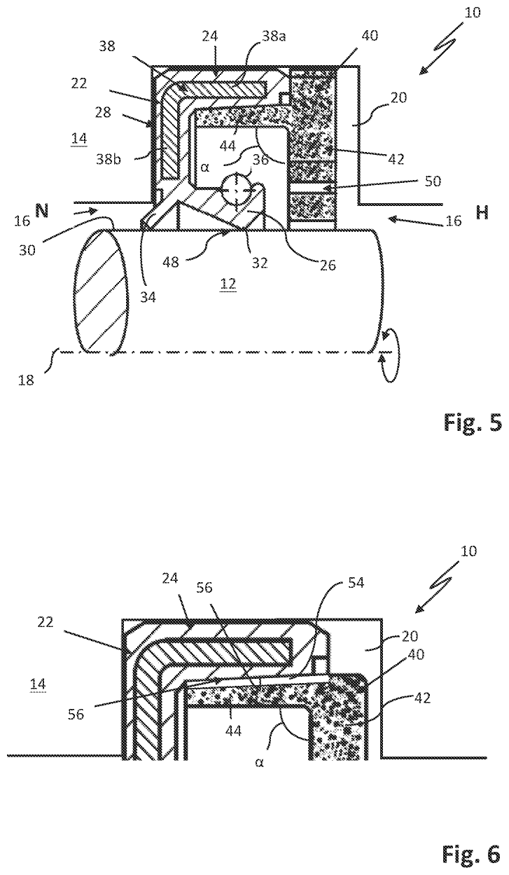

According to the rotary seal assembly 10 shown in FIG. 5, the foam ring 40 can also extend up to the second machine part 14 and bear against it in a radial direction. The foam ring 40 can thus be supported on the foot portion 24 of the rotary seal additionally in an axial direction.

The rotary seals 22 represented in the drawing are all pressure-activated, i.e., are pressed by and proportional to an operating pressure P, set on the oil side H, of a medium (for example, lubricating oil) against the sealing surface 30. For this purpose, the foam ring 40 can be provided with one or more axial through-recesses 50 in order to counteract a drop in pressure via the foam ring 40.

For even further improved positional fixing of the foam ring on the foot portion 24 of the rotary seal 22, it can according to FIG. 6 be in threaded engagement with an internal thread 52 formed on the foot portion 24. The external thread 54 of the foam ring 40 can be generated by simple screwing in of the foam ring 40 with deformation of the foam material into the internal thread 52 or alternatively by a suitable, viscoelastic plastic material applied, in particular, injection-molded, on the holding portion 44.

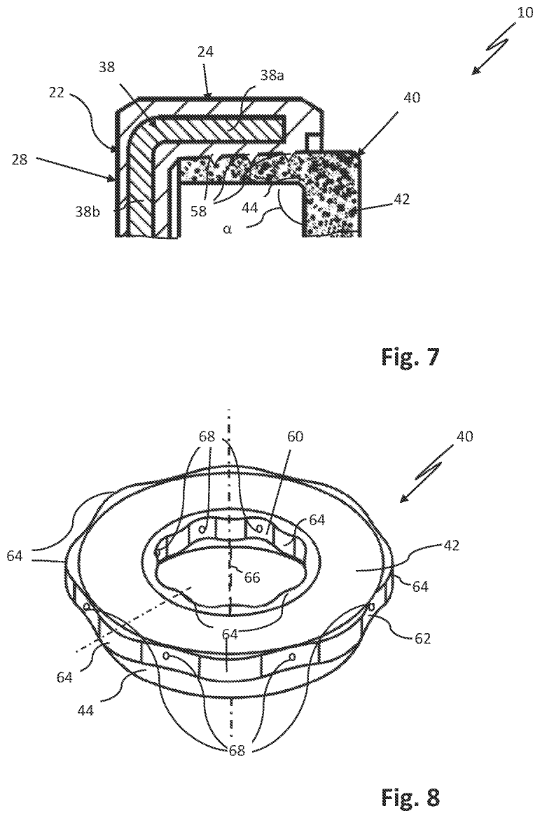

According to the embodiment shown in FIG. 7 of the rotary seal assembly 10, at least the foot portion 24 of the rotary seal 22 can have on its inner side 56 facing the foam ring 40 corrugations 58 which engage in a displacing or cutting manner into the material of the foam ring 40. The foam ring 40 can, according to an embodiment not represented in greater detail in the drawing, in the unloaded, i.e., not installed state, have corresponding corrugations 58. The corrugations 58 can be embodied in each case in the sense of teeth or also annularly.

FIG. 8 shows a foam ring 40 of a rotary seal assembly 10 according to FIGS. 1 and 2 in a perspective view. The foam ring 40 has an inner circumferential side 60 which is corrugated in the circumferential direction and an outer circumferential side 62 which is corrugated in the circumferential direction. The projections or bulges 64 which project in the radial direction from the inner circumferential side 60 and in the radial direction from the outer circumferential side 62 are arranged flush with one another in pairs in each case in the radial direction. As a result of this, a variable contact pressure distribution of the foam ring 40 on the sealing surface 30 is produced in the installation state of the foam ring 40 in the circumferential direction.

The foam ring can furthermore have—relative to its central axis 66—radial channels 68 which preferably extend from the inner circumferential side 60 up to the outer circumferential side 62 of the foam ring 40 and which serve the purpose of additional capillary lubricant absorption.

The foam rings explained above in conjunction with FIGS. 1 to 8 can be composed of a closed-celled, an open-celled or a mixed closed-celled/open-celled foam.

What is claimed is:

1. A rotary seal assembly comprising:
a first machine part in the form of a shaft;
a second machine part which engages around the shaft, wherein the first machine part and the second machine part are spaced apart from one another with the formation of a sealing gap and are arranged rotatably relative to one another about an axis of rotation;
a seal-holding structure which is formed on one of the two machine parts;
a rotary seal with a foot portion and with a sealing lip, which are connected to one another via a connecting portion, wherein the foot portion is arranged on or in the seal-holding structure and wherein the sealing lip bears in a sealing manner against a sealing surface of the respective other machine part, in order to seal off an oil side from an outer side of the rotary seal assembly; and
a foam ring arranged on the oil side and with a base body and with a holding portion, wherein the foam ring engages around the first machine part and is arranged so as to be held on the foot portion of the rotary seal via the holding portion, characterized in that
the foam ring has, at least in its unloaded, unmounted state, a corrugated inner circumferential side and/or a corrugated outer circumferential side.

2. The rotary seal assembly as claimed in claim 1, wherein the holding portion extends laterally away from the base body.

3. The rotary seal assembly as claimed in claim 1, wherein the holding portion is embodied to be in multiple parts or annularly closed in the circumferential direction.

4. The rotary seal assembly as claimed in claim 2, wherein the holding portion is embodied to be in multiple parts or annularly closed in the circumferential direction.

5. The rotary seal assembly as claimed in claim 1, wherein the foam ring is held in a clamped manner via the holding portion on the rotary seal.

6. The rotary seal assembly as claimed in claim 1, wherein the holding portion of the foam ring and/or the foot portion of the rotary seal is/are embodied in a corrugated manner.

7. The rotary seal assembly as claimed in claim 1, wherein the foam ring and the foot portion of the rotary seal are in mutual threaded engagement.

8. The rotary seal assembly as claimed in claim 1, wherein the holding portion and/or the base body of the form ring is/are supported on the foot portion of the rotary seal in an axial direction with respect to the axis of rotation.

9. The rotary seal assembly as claimed in claim 1, wherein the holding portion of the form ring extends up to the connecting portion of the rotary seal.

10. The rotary seal assembly as claimed in claim 1, wherein the rotary seal and/or the foam ring as/are provided with a reinforcement layer which has an L-shaped cross-sectional shape.

11. The rotary seal assembly as claimed in claim 1, wherein the base body of the foam ring has a cross-sectional shape which is rectangular or tapers in the direction of the sealing surface.

12. The rotary seal assembly as claimed in claim 1, wherein the foam ring bears at least in portions directly against the sealing surface.

13. The rotary seal assembly as claimed in claim 1, wherein the base body is formed at least partially from a closed-celled, an open-celled or a mixed closed-celled/open-celled foam.

14. The rotary seal assembly as claimed in claim 1, wherein the foam ring has in the circumferential direction at least one radial channel which extends from the inner circumferential side up to the outer circumferential side of the foam ring.

15. The rotary seal assembly as claimed in claim 1, wherein the rotary seal is pressure-activated and the foam ring is provided with an axial through-recess or with several axial through-recesses.

16. The rotary seal assembly as claimed in claim 1, wherein the rotary seal has a dust lip which points towards the outer side and/or bears in a pretensioned, sealed manner against the sealing surface by means of a pretensioning element.

17. The rotary seal assembly as claimed in claim 1, wherein the foam ring bears directly against the machine part which has the seal-holding structure.

18. The rotary seal assembly as claimed in claim 1, wherein the base body is formed projecting in a radial direction at least from the foot portion up to the sealing surface.
